(19) United States
(12) Patent Application Publication
(10) Pub. No.: US 2002/0183067 A1
(43) Pub. Date: Dec. 5, 2002

(54) Method and system for wirelessly transmitting data between a base transceiver station and a subscriber unit

(76) Inventors: Manish Airy, San Jose, CA (US); Ivana Stojanovic, Stanford, CA (US); Partho Mishra, Cupertino, CA (US); Huzur Saran, San Jose, CA (US)

Correspondence Address: Patent Department, Iospan Wireless, P.O. Box 641867, San Jose, CA, 95164-1867, US

(21) Appl. No.: 09/870,706

(22) Filed: Jun. 1, 2001

(51) Int. Cl. H04Q 7/20

(52) U.S. Cl. 455/455; 455/452

(57) ABSTRACT

The present invention includes a method and system for wirelessly transmitting data between a plurality of subscriber units and a base transceiver station. The method comprises at least one subscriber unit transmitting a service flow request to the base transceiver station, determining if the service flow request was received by the base transceiver station, utilizing a back-off algorithm to re-transmit the service flow request if the service flow request was not received by the base transceiver station and transmitting data blocks to the base transceiver station based on the service flow request. The system comprises a base transceiver station and a subscriber unit, the subscriber unit comprising means for transmitting a service flow request to the base transceiver station means for determining if the service flow request was received by the base transceiver station, means for utilizing a back-off algorithm to re-transmit the service flow request if the service flow request was not received by the base transceiver station and means for transmitting data blocks to the base transceiver station based on the service flow request.

### FIELD OF THE INVENTION

The invention relates generally to wireless communications. More particularly, the invention relates to scheduling of data wirelessly transmitted between a base control station having multiple antennas, and subscriber units.

### BACKGROUND OF THE INVENTION

Wireless communication systems commonly include information carrying modulated carrier signals that are wirelessly transmitted from a transmission source (for example, a base transceiver station) to one or more subscribers (for example, subscriber units) within an area or region.

FIG. 1 shows a portion of a single cell of a cellular wireless network system. A base transceiver station 110 provides a wireless connection to subscriber units 120, 130. The base transceiver station is generally connected to a network that provides access to the Internet. The cell of FIG. 1 is generally repeated forming a cellular network. The base transceiver station 110 and the subscriber units 120, 130 include one or more antennas allowing two-way communication between the base transceiver station 110 and the subscriber units 120, 130.

Generally, information is transmitted between the base transceiver station 110 and the subscriber units 120, 130 in packets or units of data. Typically, a schedule or map must be generated that determines when the units of data are transmitted between base transceiver station 110 and subscriber units 120, 130. The bandwidth of the available transmission frequencies is limited. Consequently, the larger the number of base station transceivers and subscriber units, the more complex the scheduling or mapping.

The transmission can be time division duplex (TDD). That is, the down link transmission (transmission from the base transceiver station to a subscriber unit) can occupy the same channel (same transmission frequency) as the up link transmission (transmission from a subscriber unit to the base transceiver station), but occur at different times. Alternatively, the transmission can be frequency division duplex (FDD). That is, the down link transmission can be at a different frequency than the up link transmission. FDD allows down link transmission and up link transmission to occur simultaneously.

Generally, wireless systems are not as reliable as wired system. As a result, data being transferred between a base transceiver station and a subscriber can be miscommunicated or lost. This condition makes the scheduling difficult, because of difficulties in determining whether data must be rescheduled and retransmitted due to being lost. Tracking the amount of data to be transferred at both the base transceiver station and at the subscriber unit aids in the management of the wireless transmission of data between the base transceiver station and the subscriber unit.

Typically, when a subscriber unit powers up, it sends a service flow request to an associated base transceiver station. A service flow request represents a bi-directional demand for data (up stream and down stream) between a base transceiver station and a subscriber unit. This request is transmitted via a contention channel that is common to a plurality of subscriber units. However, if for some reason the service flow request is not heard by the base transceiver station, (e.g. the request “collides” with another request and is lost, the base transceiver station is busy, etc.) the request must be re-transmitted.

It is therefore desirable to have a method and system for allowing a subscriber unit to effectively re-transmit a service flow request. The method and system should be cost effective and capable of being easily adapted to existing technology. The present invention addresses such a need.

### SUMMARY OF THE INVENTION

The invention includes a method and system for the wireless transmission of data blocks between a base transceiver station and multiple subscriber units. The method and system preferably utilizes a back-off algorithm in order to re-transmit service flow requests that are lost or otherwise not heard by the base transceiver station.

A first embodiment of the invention includes a method for wirelessly transmitting data between a plurality of subscriber units and a base transceiver station. The method comprises at least one subscriber unit transmitting a service flow request to the base transceiver station, determining if the service flow request was received by the base transceiver station, utilizing a back-off algorithm to re-transmit the service flow request if the service flow request was not received by the base transceiver station and transmitting data blocks between the base transceiver station and the at least one subscriber unit based on the service flow request.

A second embodiment of the invention also includes a method for wirelessly transmitting data between a plurality of subscriber units and a base transceiver station. The method comprises the base transceiver station receiving a service flow request from a subscriber unit, determining if the base transceiver station is backlogged and determining if the base transceiver station is slow in processing service flow requests or if a scheduler is overloaded.

A third embodiment of the present invention includes a system for wirelessly transmitting data. The system comprises a base transceiver station and a subscriber unit, the subscriber unit comprising means for transmitting a service flow request to the base transceiver station means for determining if the service flow request was received by the base transceiver station, means for utilizing a back-off algorithm to re-transmit the service flow request if the service flow request was not received by the base transceiver station and means for transmitting data blocks between the base transceiver station and the at least one subscriber unit based on the service flow request.

A fourth embodiment of the present invention also includes a system for wirelessly transmitting data. The system comprises a subscriber unit and a base transceiver station, the base transceiver station comprising means for receiving a service flow request from the subscriber unit, means for determining if the base transceiver station is backlogged and means for determining if the base transceiver station is slow in processing or if a scheduler is overloaded.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes spatially separate transmitters.

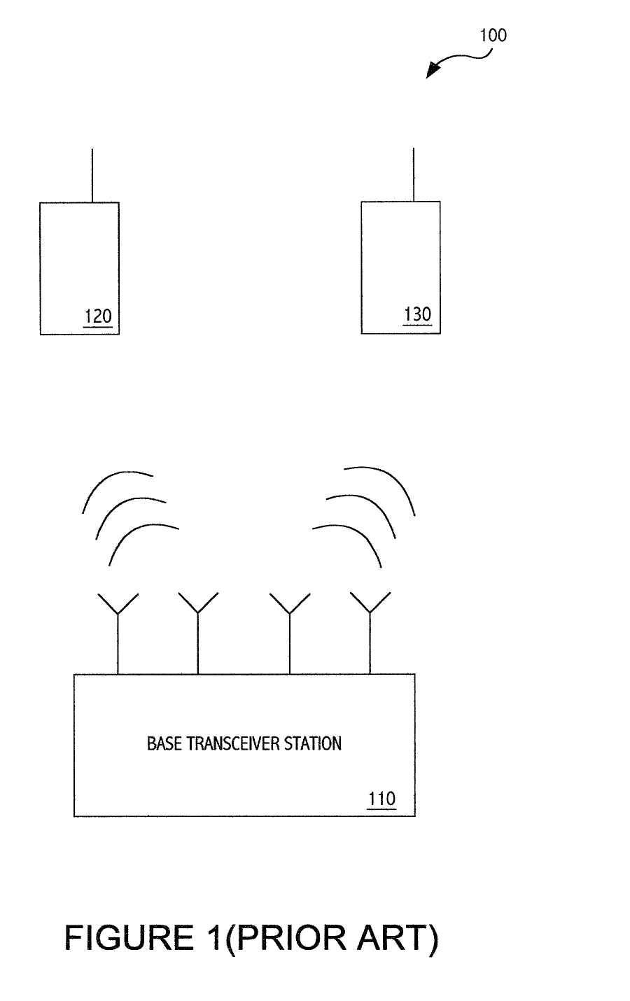

FIG. 2 shows an embodiment of the invention.

FIG. 3A shows a set of service flow requests that indicate demands for data by subscriber units.

FIG. 3B shows a set of estimated service flow buffer sizes that indicate demands for up link data by subscriber units.

FIG. 4A shows a frame structure depicting blocks of transmission data defined by transmission time and transmission frequency.

FIG. 4B shows an up link frame structure that is transmitted at one frequency band, and a down link frame structure that is transmitted at another frequency band.

FIG. 4C shows an up link frame structure that is transmitted at a first time, and a down link frame structure that is transmitted at a second time.

FIG. 5 is a high-level flowchart of the method in accordance with the present invention.

FIG. 6 is a flowchart of the back-off algorithm.

### DETAILED DESCRIPTION

The present invention relates to a method and system for scheduling wireless transmission of data blocks between at least one antenna of a base transceiver station and multiple subscriber units. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the invention is embodied in a system and a method for the wireless transmission of data blocks between a base transceiver station and multiple subscriber units. The method and system preferably utilizes a back-off algorithm in order to re-transmit service flow requests that are lost or otherwise not heard by the base transceiver station.

As previously described, the invention includes wireless communication between at least one base transceiver station and subscriber units. The communications is two-way. That is, information is transmitted from the base transceiver station to the subscriber units (down link transmission), and information is transmitted from the subscriber units to the base transceiver station (up link transmission).

The transmission can be time division duplex (TDD). That is, the down link transmission can occupy the same channel (same transmission frequency) as the up link transmission, but occur at different times. Alternatively, the transmission can be frequency division duplex (FDD). That is, the down link transmission can be at a different frequency than the up link transmission. FDD allows down link transmission and up link transmission to occur simultaneously. The following discussion of the invention generally includes FDD. However, it should be understood that a TDD implementation is feasible.

As previously discussed, multiple subscriber units are in communication with at least once base transceiver station antenna. Multi-point wireless communication systems like this, can include time division multiplexing (TDM), frequency division multiplexing (FDM), code division multiplexing (CDM), spatial division multiplexing (SDM), or any combination thereof, for communicating with multiple units. The following discussion of the invention includes a TDM-FDM combination. However, it is to be understood that other combinations of the above describe multiplexing schemes can be implemented.

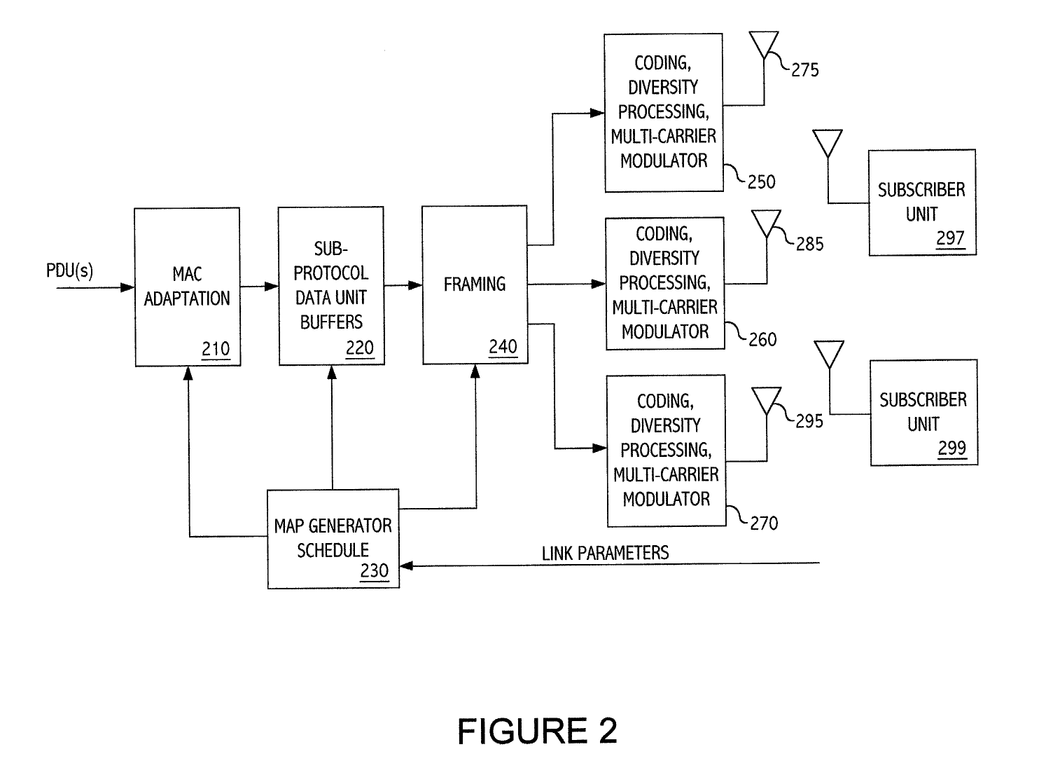

FIG. 2 shows an embodiment of the invention. The embodiment includes a base station transceiver receiving standard protocol data units (PDU's). The PDU's are divided into smaller sub-protocol data units that are stored in memory. A schedule is generated that designates time slots and frequency blocks in which the sub-protocol data units are to be transmitted to each of the subscriber units, and time slots and frequency blocks in which other sub-protocol data units are to be transmitted from the subscriber units to the base station transceiver based on service flow requests made by the subscriber units and the base station transceiver.

A media access control (MAC) adaptation unit 210 receives the protocol data units from a standard computer network. The protocol data units can be Ethernet or ATM frames, or Internet protocol (IP) or frame relay packets. The MAC adaptation unit 210 divides the protocol data units into smaller sub-protocol data units that are more adaptable for transmission within wireless communication systems. The smaller sub-protocol data units facilitate more efficient error recovery through retransmission. Wireless channels tend to vary often. The smaller size of the sub-protocol data units makes it more likely that the data units will experience a steady channel during transmission.

The digital circuitry or software required to divide or break large groups of data into smaller groups of data is well known in the art of digital circuit and software design.

The sub-protocol data units are stored within sub-protocol data buffers 220. The sub-protocol data buffers 220 provide a scheduler 230 with easy access to the sub-protocol data.

The scheduler 230 generates a map or schedule of when the sub-protocol data units are to be transmitted, which sub-protocol data units are to be received by which subscriber unit, and when and at what frequency band the subscriber units can transmit sub-protocol data units back to the base station transceiver. The map is broadcasted to the subscriber units so that each subscriber unit knows when to receive and transmit sub-protocol units. A map is broadcasted once per unit of time. The unit of time is generally referred to as a frame. The time duration of a frame is variable.

The scheduler 230 receives information regarding the service class of the subscriber units. Additionally, the scheduler 230 receives data requests from the subscriber units. The data requests include information regarding the size and data type of data to be transmitted. The scheduler then utilizes this information for generating the schedule.

The scheduler 230 accesses the sub-protocol data units within the sub-protocol data buffers 220. Each data request can have a dedicated buffer within the sub-protocol data buffers 220. A predetermined number of sub-protocol data units are retrieved by the scheduler 230 and ordered within a frame within a framing unit 240. A map of the schedule is included within every frame for the purpose of indicating to each subscriber unit when (that is, which time slot) and at what frequency data blocks requested by the subscriber unit will be transmitted, and when and at what frequency data blocks can be transmitted from the subscriber unit.

Multi-carrier modulator units 250, 260, 270 each generate a plurality of multiple-carrier modulated signals. Each multi-carrier modulator 250, 260, 270 receives a processed sub-protocol data unit stream and generates a multiple-carrier modulated signal based on the corresponding processed sub-protocol data unit stream. The multiple-carrier modulated signals are frequency up-converted and amplified as is well known in the art of communication systems.

An output of a first multi-carrier modulator 250 is connected to a first transmit antenna 275. An output of a second multi-carrier modulator 260 is connected to a second transmit antenna 285. An output of a third multi-carrier modulator 270 is connected to a third transmit antenna 295. The first transmit antenna 275, the second transmit antenna 285, and the third transmit antenna 295 can be located within an antenna array at a single base station. Alternatively, the first transmit antenna 275, the second transmit antenna 285, and the third transmit antenna 295 can each be located at separate base stations. The first transmit antenna 275, the second transmit antenna 285, and the third transmit antenna 295 can have different polarization states, and be either physically co-located at a single base station, or each located at separate base stations. Circuitry associated with the transmit chains can be separately located with the antennas 275, 285, 295.

The embodiment of FIG. 2 includes three transmit antennas. It is to be understood that the invention can include two or more transmit antennas. The additional antennas can be driven by additional multi-carrier modulators that each include separate corresponding processed sub-protocol data unit streams.

The embodiment of FIG. 2 can further include subscribers units 297, 299. The subscribers units 297, 299 can include multiple spatially separate subscriber antennae.

Multiple transmitter antennae and multiple subscriber antennae allow the wireless communication system to include spatial multiplexing and communication diversity. As described earlier, spatial multiplexing and communication diversity can improve the capacity of the communication system and reduce the effects of fading and multi-path resulting in increased capacity.

Down Link Service Flow Request

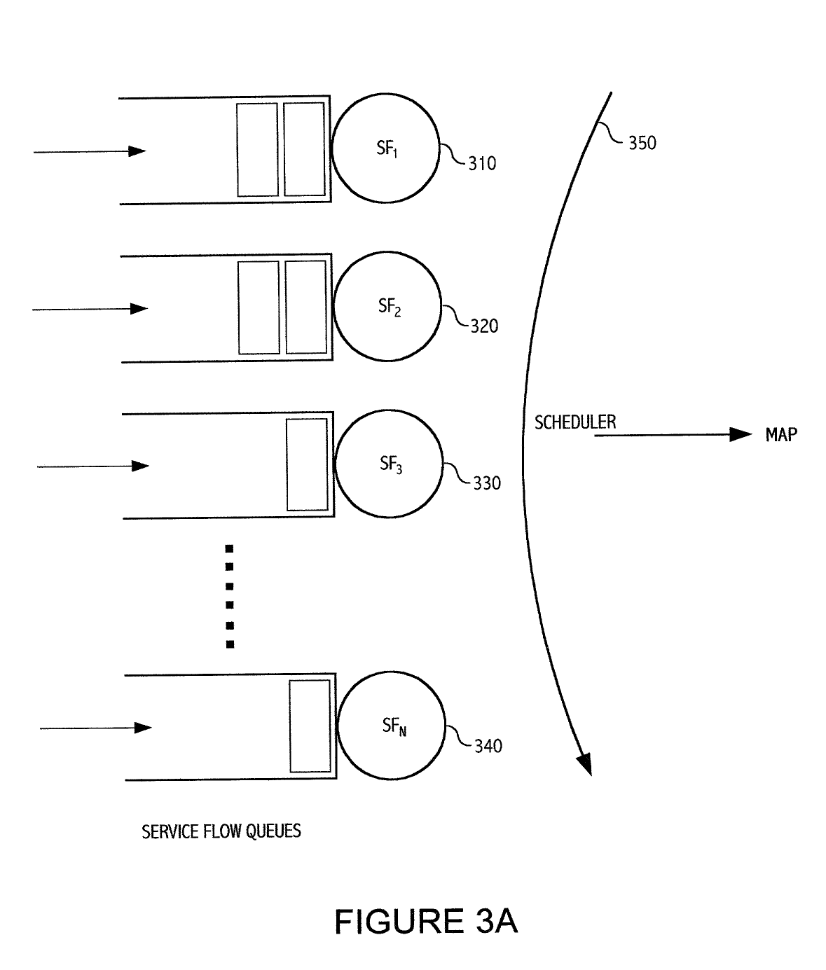

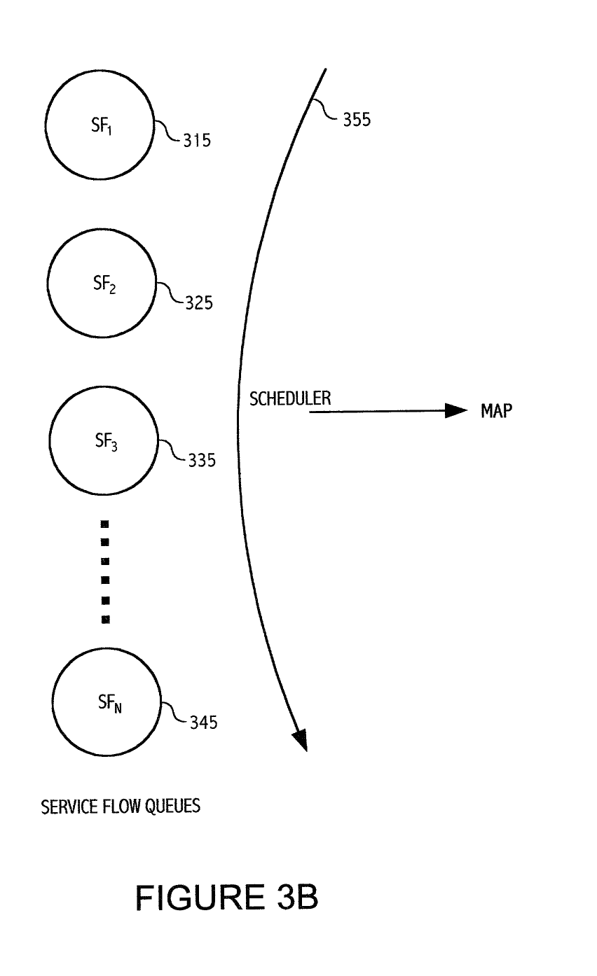

FIG. 3A shows a set of service flow buffers 310, 320, 330, 340 that contain sub-protocol data units for subscriber units. The scheduler uses the service flow buffers 310, 320, 330, 340 to generate the sub-protocol data transmission schedule. The service flow buffers can contain different sizes of data. The scheduler addresses the service flow buffers, and forms the schedule.

The service flow buffers 310, 320, 330, 340 contain data for the subscriber units. The buffers 310, 320, 330, 340 contain data received from the network generally in response to requests sent from the subscriber units. The buffers 310, 320, 330, 340 are accessible by a processor within the base transceiver station.

The service flow buffers 310, 320, 330, 340 can contain a variety of types, and amounts of data. As will be described later, these factors influence how the scheduler maps the data demanded by the subscriber units.

The scheduler accesses service flow buffers 310, 320, 330, 340, during the generation of the map of the schedule.

As depicted in FIG. 3A by arrow 350, an embodiment of the scheduler includes addressing each service flow sequentially and forming the map of the schedule. As will be described later, the data blocks dedicated to each service flow request is dependent upon a block weight. The block weight is generally dependent upon the priority of the particular demand for data.

Up Link Service Flow Request

FIG. 3B shows a set of estimated service flow buffer sizes 315, 325, 335, 345 based upon the service flow that indicate demands for up link data by subscriber units. The scheduler uses the estimated service flow buffer sizes 315, 325, 335, 345 to generate the sub-protocol data up link transmission schedule. The scheduler addresses the estimated service flow buffer sizes forming the schedule.

The estimated service flow buffer sizes 315, 325, 335, 345 are estimated demands for data by the subscriber units. The estimated service flow buffer sizes 315, 325, 335, 345 are generally wirelessly received from the subscriber units by the base transceiver station. The estimated service flow buffer sizes 315, 325, 335, 345 can be queued in memory buffers that are accessible by a processor within the base transceiver station.

As depicted in FIG. 3B by arrow 355, an embodiment of the scheduler includes addressing each estimated service flow buffer size sequentially and forming the map of the schedule. As will be described later, the data blocks dedicated to each estimated service buffer size is dependent upon a block weight. The block weight is generally dependent upon the priority of the particular demand for data.

Frame Structure

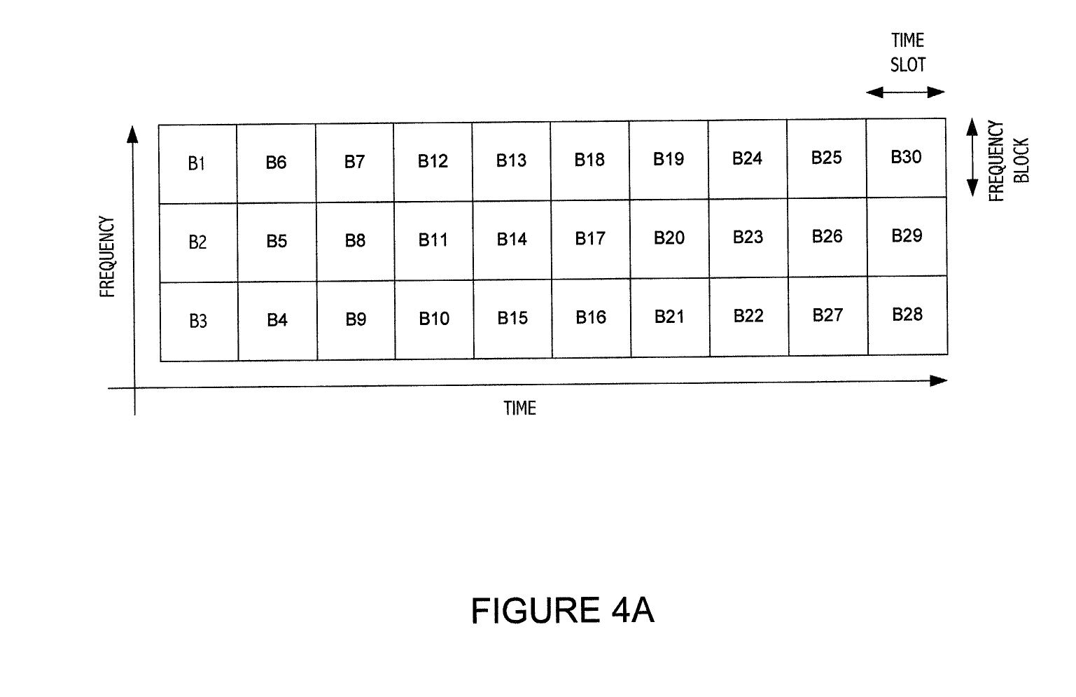

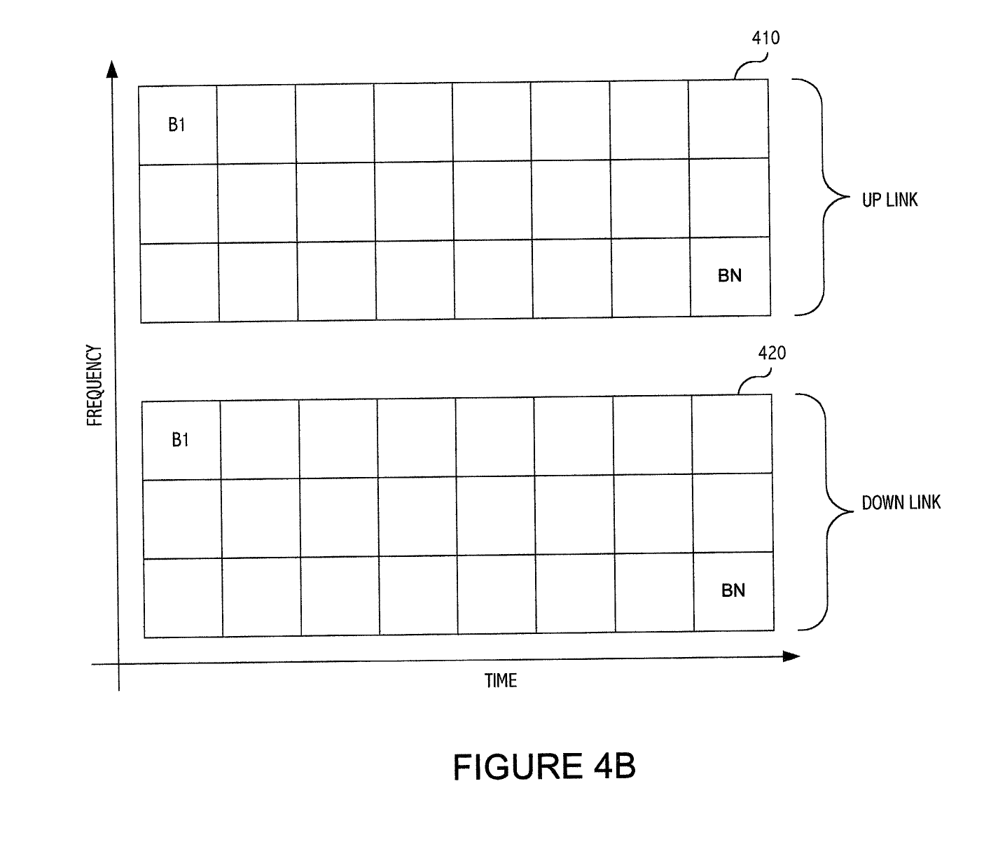

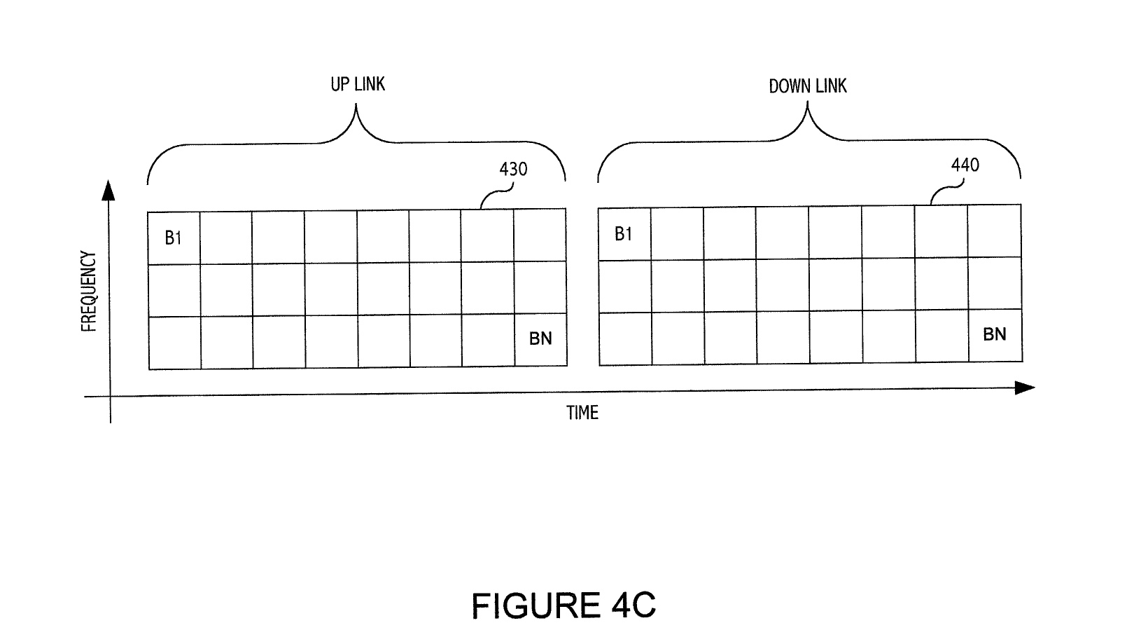

FIG. 4A shows a frame structure depicting blocks of transmission data defined by transmission time slots and transmission frequency blocks. The scheduler maps requests to transmit or receive data into such a frame structure. For example, data blocks B1, B2 and B3 can be transmitted during a first time slot, but over different frequency ranges or blocks. Data blocks B4, B5 and B6 are transmitted during a second time slot, but over different frequency ranges or blocks than each other. The different frequency ranges can be defined as different groupings or sets of Orthogonal Frequency Division Multiplexing symbols.

As depicted in FIG. 4A, the entire transmission frequency range includes three frequency blocks within a frame. Data blocks B1, B6, B7, B12, B13, B18, B19, B24, B25 and B30 are transmitted over common frequency ranges, but within different time slots. As depicted in FIG. 4A, ten time slots are included within a single frame. The number of time slots per frame is not necessarily fixed. The numbering of the data blocks is depicted in the order chosen because of ease of implementation.

FIG. 4B shows two frames 410, 420. A first frame 410 can be designated as the up link frame, and a second frame 420 can be designated as the down link frame. As shown in FIG. 4B, the up link frame 410 occupies a different frequency band than the down link frame 420. As described before, the frames include a finite number of frequency blocks and time slots. The frames 410, 420 of FIG. 4B are consistent with FDD transmission.

FIG. 4C also shows two frames 430, 440. A first frame 430 can be designated as the up link frame, and a second frame 440 can be designated as the down link frame. As shown in FIG. 4C, the up link frame 430 occupies a different time duration than the down link frame 440. As described before, the frames include a finite number of frequency blocks and time slots. The frames 430, 440 of FIG. 4C are consistent with TDD transmission.

Based on information received by the base transceiver station, the scheduler designates one or more blocks as contention blocks. These contention blocks represent a contention channel whereby associated subscriber units transmit service flow requests to the base transceiver station. A service flow request represents a bi-directional demand for data (up stream and down stream) between a base transceiver station and a subscriber unit.

The number of contention blocks can vary frame to frame, based on the amount of data being transmitted i.e. if less data is being transmitted, more blocks can be designated as contention blocks. Because multiple subscriber units are making service flow requests simultaneously, some requests “collide” at the contention channel and are lost. These lost requests must be appropriately re-transmitted in order for the associated subscriber unit to be “heard” by the base transceiver station. In accordance with present invention, the method and system allow a back-off algorithm to be utilized in order to re-transmit the lost service flow request and insure that the service flow request is heard by the base transceiver station.

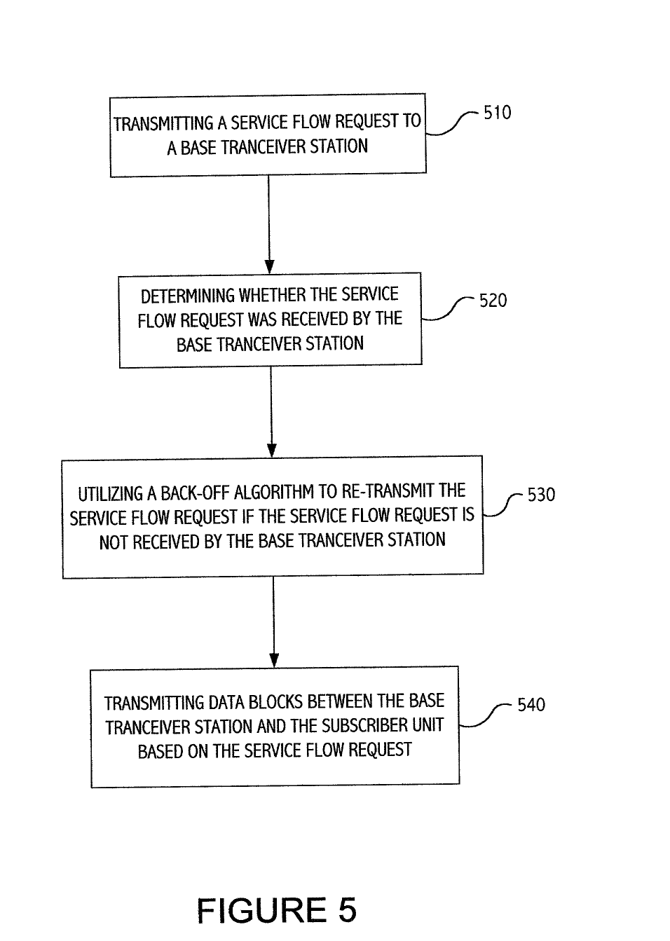

For a better understanding of the method in accordance with the present invention, please refer to FIG. 5. FIG. 5 is a high-level flowchart of the method in accordance with the present invention. First, at least one subscriber unit transmits a service flow request to a base transceiver station, via step 510. Next, a determination is made as to whether the service flow request was received by the base transceiver station, via step 520. This step preferably involves determining if the base transceiver station is backlogged.

The determination is made as to whether the base transceiver station is backlogged by checking the number of the last frame processed by the base transceiver station. The base transceiver station keeps track of each frame that is processed by the base transceiver station. Each time the base transceiver station processes a frame, the base transceiver station will increment the last frame processed by one, e.g. if frame number 6 is processed by the base transceiver station, the last frame processed is incremented from 5 to 6. However, if the base transceiver station is backlogged, the base transceiver station will stop processing frames.

Accordingly, in order to determine whether the base transceiver station is backlogged, the scheduler compares the number of the frame in which the service flow request was sent with the number of the last frame processed by the base transceiver station. If the number of the last frame processed by the base transceiver station is less than the number of the frame in which the service flow request was sent, then the base transceiver station is backlogged with service flow requests.

If the base transceiver station is backlogged, it is based on one of two reasons. Either the base transceiver station is slow in processing or the scheduler is overloaded. The base transceiver station logic then determines which of these conditions is causing the backlog. If the base transceiver station is slow in processing, the base transceiver station simply waits to process the service flow request. Alternatively, if the scheduler is overloaded, a signal is transmitted to the subscriber unit indicating that the allocation of bandwidth for the corresponding service flow request is pending.

Referring back to FIG. 5, a back-off algorithm is then utilized to re-transmit the service flow request, if the service flow request is not received by the base transceiver station, via step 530. Finally, data blocks are transmitted between the base transceiver station and the at least one subscriber unit based on the service flow request, via step 540.

The back-off algorithm is implemented to prevent the collision of re-transmitted service flow requests that have initially collided with other service flow requests at the contention channel. Incorporated into the execution of the back-off algorithm is a contention window. The contention window is the number of contention opportunities that a subscriber unit waits before transmitting a service flow request.

Once the subscriber unit powers up, the contention window is assigned an initial value, Wᵢₙᵢₜ. Based on this value, the subscriber unit transmits a service flow request to the base transceiver station. If that request is not heard by the base transceiver station, the contention window is then adjusted. Preferably, this adjustment comprises multiplying the contention window by 2 or some other number.

It should be noted that since each iteration of the algorithm preferably comprises multiplying the contention window by 2, the adjusted contention window is characterized as 2ⁿ where n is the number of algorithm iterations. Consequently, in order to prevent the adjusted contention window from becoming too large, a maximum value, Wₘₐₓ is set for the adjusted contention window.

Based on the load level, contention window parameters (Wᵢₙᵢₜ, Wₘₐₓ) can be changed. For example, if the base transceiver station is experiencing a high load, a larger value of Wᵢₙᵢₜ is utilized whereas if the base transceiver station is experiencing a low load a smaller value of Wᵢₙᵢₜ is utilized. Furthermore, the larger the number of active subscriber units, the larger the value of Wₘₐₓ. The load level is based on the weighted average of the number of service flow requests transmitted by all of the subscriber units in communication with the base transceiver station.

The base transceiver station maintains the weighted average of the number of service flow requests transmitted by all of the subscriber units in communication with the base transceiver station. That is, all of the subscriber units monitor the number of times service flow requests are transmitted before being successfully received. This number is transmitted with each service flow request. The base transceiver station maintains a weighted average of the number from all of the subscriber units transmitting to base transceiver station. The weighted average can be designated as the “SFR retries.” For example,

(SFR retries (weighted average))_{N+1}=K*(SFR retries)_{N}+(1−K)*(number of SFR retries of the just received SFR signal). Where K is a weighting factor that varies from zero to one.

A weighted average is used rather than a strict average because particular subscriber units may have a problem with its service flow request being received. A weighted average is less likely to be skewed by such a subscriber.

The weighted average can also include averaging over a fixed time window of the SFR retries. Therefore, only the most recent SFR retries influence the weighted average.

The SFR retries (weighted average) is then compared with a set of thresholds. If the SFR retries is greater than a first threshold, then a loading level designator is incremented. If the SFR retries is less than a second threshold, then the loading level is decremented. For example, the loading level can include a high (H), medium (M) and low (L) levels. A default initial level can be M. Depending upon the value of a present or most recent SFR retries value, the loading level can be incremented to H, or decremented to L. As the SFR retries value varies, the loading level is modified accordingly. The number of discrete load levels can include more than three levels.

Once the contention window is adjusted, a back-off time is calculated based on the adjusted contention window. The back-off time is the amount of time that the subscriber unit will wait before re-transmitting the service flow request. This time is preferably calculated based on the number of opportunities that the subscriber unit has to re-transmit the service flow request. Preferably, a transmission opportunity comprises a contention block within a frame e.g. a frame with 3 contention blocks has 3 transmission opportunities.

Accordingly, the back-off time preferably comprises a randomly selected number between 1 and the adjusted contention window. For example, if the adjusted contention window is 6, then the back-off time is a randomly selected number between 1 and 6. By randomly selecting the number, it reduces the likelihood that multiple subscriber units will have the same back-off time. This is necessary because if multiple subscriber units have the same back-off time, the service flow requests will continue to collide with one another at the contention channel.

Once the back-off time (the randomly selected number between 1 and the adjusted contention window) is determined, the service flow request is re-transmitted based on the back-off time. For example, if the back-off time is 6, the subscriber unit preferably waits for the passage of 6 transmission opportunities (6 contention blocks) and then retransmits the service flow request on the 7^{th} transmission opportunity.

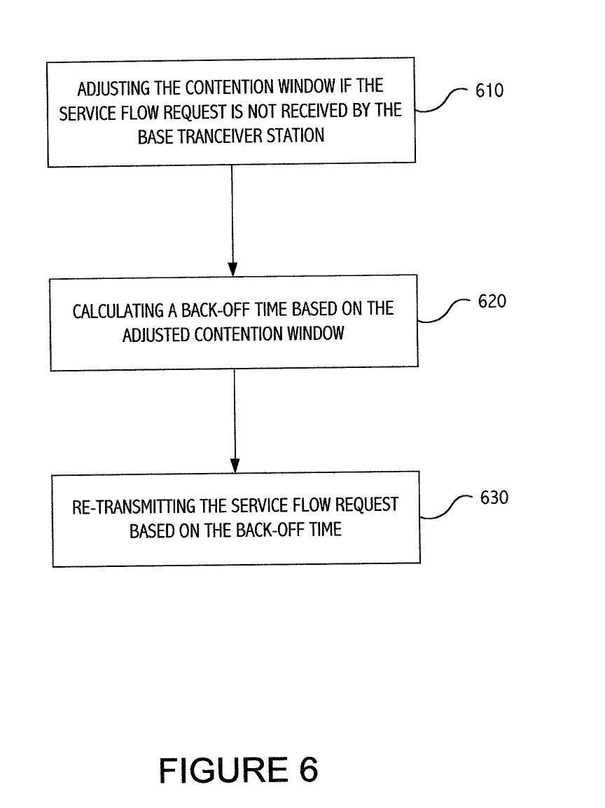

For a better understanding of the back-off algorithm, please refer now to FIG. 6. FIG. 6 is a flowchart of the back-off algorithm. First, if the service flow request is not received by the base transceiver station, the contention window is adjusted, via step 610. Preferably, this adjustment comprises multiplying the current contention window by 2. Next, a back-off time is calculated based on the adjusted contention window, via step 620. Preferably, the back-off time is comprises randomly selecting a number between 1 and the adjusted contention window. Finally, the service flow request is re-transmitted based on the back-off time, via step 630.

Polling

To effectively manage loading on the contention channel, subscriber units can be polled over a period of time by the base transceiver station if they are in a polling mode and consequently will not send requests over the contention channel. Preferably, the polling period is variable. If a subscriber unit has a pending request and is in the polling mode, the scheduler maintains the request and waits for an allocation of bandwidth by the base transceiver station. Otherwise, if the polling period is too large, the subscriber unit can transmit the request via the contention channel.

The above-described invention includes a method and system for the wireless transmission of data blocks between a base transceiver station and multiple subscriber units. The method and system preferably utilizes a back-off algorithm in order to re-transmit service flow requests that are lost or otherwise not heard by the base transceiver station.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

What is claimed:

1. A method for wirelessly transmitting data between a plurality of subscriber units and a base transceiver station, the method comprising:
at least one subscriber unit transmitting a service flow request to the base transceiver station;
determining if the service flow request was received by the base transceiver station;
utilizing a back-off algorithm to re-transmit the service flow request if the service flow request was not received by the base transceiver station; and
transmitting data blocks to the base transceiver station based on the service flow request.

2. The method of claim 1 wherein determining if the service flow request was received by the base transceiver station comprises:
determining if the base transceiver station is backlogged; and
determining if the base transceiver station is slow in processing or if a scheduler is overloaded if the base transceiver station is backlogged.

3. The method of claim 2 wherein the base transceiver station is backlogged if a last frame processed is less than the frame number in which the service flow request was sent.

4. The method of claim 2 wherein the at least one subscriber unit receives an allocation pending indication if the scheduler is overloaded.

5. The method of claim 1 wherein the request is transmitted via a contention channel of a data frame.

6. The method of claim 5 wherein the back-off algorithm comprises:
adjusting a contention window;
calculating a back-off time based on the adjusted contention window; and
re-transmitting the service flow request based on the back-off time.

7. The method of claim 6 wherein adjusting the contention window comprises multiplying a current contention window by two.

8. The method of claim 6 wherein the contention window comprises a minimum value and a maximum value wherein the minimum value and maximum value can be changed.

9. The method of claim 6 wherein calculating the back-off time comprises randomly selecting a number between 1 and the adjusted contention window.

10. The method of claim 9 wherein re-transmitting the service flow request based on the back-off time comprises:
waiting for a predetermined number of transmission opportunities; and
re-transmitting the service flow request at the next transmission opportunity.

11. The method of claim 10 wherein a transmission opportunity comprises a contention block within a frame.

12. The method of claim 11 wherein the number of contention blocks in each frame is variable.

13. The method of claim 10 wherein the predetermined number of transmission opportunities is equal to the randomly selected number between 1 and the adjusted contention window.

14. The method of claim 1 further comprising polling the at least one subscriber unit if the at least one subscriber unit is in a polling mode.

15. The method of claim 14 wherein if the at least one subscriber unit is in the polling mode, the at least one subscriber unit may not transmit a service flow request over the contention channel.

16. A method for wirelessly transmitting data between a plurality of subscriber units and a base transceiver station, the method comprising:
the base transceiver station receiving a service flow request from a subscriber unit;
determining if the base transceiver station is backlogged; and
determining if the base transceiver station is slow in processing or if a scheduler is overloaded if the base transceiver station is backlogged.

17. The method of claim 16 wherein the base transceiver station is backlogged if a last frame processed is less than the frame in which the request was sent.

18. The method of claim 17 further comprising:
transmitting an allocation pending indication to the subscriber unit if the scheduler is overloaded.

19. The method of claim 17 wherein the service flow request is transmitted via a contention channel of a data frame.

20. The method of claim 19 wherein the number of contention blocks in each frame is variable.

21. The method of claim 16 further comprising polling the subscriber unit over a period of time if the subscriber unit is in a polling mode.

22. The method of claim 21 wherein the base transceiver station indicates allocations in the scheduler for subscriber units that are in the polling mode.

23. The method of claim 22 wherein the period of time is variable.

24. A system for wirelessly transmitting data the system comprising:
a base transceiver station; and
a subscriber unit, the subscriber unit comprising:
means for transmitting a service flow request to the base transceiver station;
means for determining if the service flow request was received by the base transceiver station;
means for utilizing a back-off algorithm to re-transmit the service flow request if the request was not received by the base transceiver station; and
means for transmitting data blocks to the base transceiver station based on the service flow request.

25. The system of claim 24 wherein the means for determining if the service flow request was received by the base transceiver station comprises:
means for determining if the base transceiver station is backlogged; and
means for determining if the base transceiver station is slow in processing or if a scheduler is overloaded if the base transceiver station is backlogged.

26. The system of claim 25 wherein the base transceiver station is backlogged if a last frame processed is less than the frame number in which the service flow request was sent.

27. The system of claim 25 wherein the at least one subscriber unit receives an allocation pending indication if the scheduler is overloaded.

28. The system of claim 25 wherein the service flow request is transmitted via a contention channel of a data frame.

29. The system of claim 28 wherein the means for utilizing a back-off algorithm comprises:
means for adjusting a contention window;
means for calculating a back-off time based on the adjusted contention window; and
means for re-transmitting the service flow request based on the back-off time.

30. The system of claim 29 wherein adjusting the contention window comprises multiplying a current contention window by two.

31. The system of claim 29 wherein the contention window comprises a minimum value and a maximum value wherein the minimum value and maximum value can be changed.

32. The system of claim 29 wherein the means for calculating the back-off time comprises means for randomly selecting a number between 1 and the adjusted contention window.

33. The system of claim 32 wherein the means for re-transmitting the service flow request based on the back-off time comprises:
means for waiting for a predetermined number of transmission opportunities; and
means for re-transmitting the service flow request at the next transmission opportunity.

34. The system of claim 33 wherein a transmission opportunity comprises a contention block within a frame.

35. The system of claim 34 wherein the number of contention blocks in each frame is variable.

36. The system of claim 33 wherein the predetermined number of transmission opportunities is equal to the randomly selected number between 1 and the adjusted contention window.

37. The system of claim 25 further comprising means for polling the at least one subscriber unit if the at least one subscriber unit is in a polling mode

38. A system for wirelessly transmitting data the system comprising:
a subscriber unit; and
a base transceiver station, the base transceiver station comprising:
means for receiving a service flow request from the subscriber unit;
means for determining if the base transceiver station is backlogged; and
means for determining if the base transceiver station is slow in processing or if a scheduler is overloaded if the base transceiver station is backlogged.

39. The system of claim 38 wherein the base transceiver station is backlogged if a last frame processed is less than the frame in which the request was sent.

40. The system of claim 39 further comprising:
means for transmitting an allocation pending indication to the subscriber unit if the scheduler is overloaded.

41. The system of claim 39 wherein the service flow request is transmitted via a contention channel of a data frame.

42. The system of claim 41 wherein the number of contention blocks in each frame is variable.

43. The system of claim 38 wherein the base transceiver station further comprises means for polling the subscriber unit over a period of time if the subscriber unit is in a polling mode.

44. The system of claim 43 wherein the base transceiver station further comprises means for indicating allocations in the scheduler for subscriber units that are in the polling mode.
